(19) United States
(12) Patent Application Publication
(10) Pub. No.: US 2013/0111356 A1
(43) Pub. Date: May 2, 2013

(54) INBOUND AND OUTBOUND COMMUNICATIONS AGGREGATED BY GROUP

(71) Applicants: Lavanya Vasudevan, Sammamish, WA (US); Gregory Alan Howard, Kirkland, WA (US); Naud Frijlink, Seattle, WA (US); Shawn M. Thomas, Bothell, WA (US)

(72) Inventors: Lavanya Vasudevan, Sammamish, WA (US); Gregory Alan Howard, Kirkland, WA (US); Naud Frijlink, Seattle, WA (US); Shawn M. Thomas, Bothell, WA (US)

(73) Assignee: MICROSOFT CORPORATION, Redmond, WA (US)

(21) Appl. No.: 13/282,487

(22) Filed: Oct. 27, 2011

(51) Int. Cl. G06F 3/01; G06F 15/16

(52) U.S. Cl. 715/753

(57) ABSTRACT

Embodiments enable the display of aggregated notifications in a group icon and enable communication with members of a group via the icon. Groups are defined to each include a plurality of members. As communications are received (e.g., by a mobile computing device), the communications are filtered to identify the communications from members of the defined groups. Notifications representing the filtered communications are created and aggregated for each of the groups. The aggregated notifications are provided for display to the user in a single icon corresponding to each of the defined groups. In some embodiments, the user is able to send communications to each of the members of a group via the single icon.

### BACKGROUND

As more users rely on electronic communications such as text messaging, voice calls, electronic mail, chat, and more, the volume of these electronic communications received by any one user has increased substantially. Many users struggle to process incoming communications, let alone take the time to send replies and/or selectively share content such as photos. Some existing systems allow users to group received communications, while other existing systems allow users to categorize sent communications. Still another system allows users to group contacts into social circles.

### SUMMARY

Embodiments of the disclosure display aggregated notifications in an icon and enable communication with members of a group via the icon. A group is defined to include a plurality of members. A computing device receives one or more communications. The received communications are filtered to identify communications received from one or more of the members of the defined group. The computing device aggregates notifications corresponding to the filtered communications and provides, for display on the computing device, the aggregated notifications in a single icon corresponding to the defined group.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device of a user communicating with content providers via a network.

FIG. 2 is an exemplary flow chart illustrating operation of the computing device to send and receive communications via a group icon.

FIG. 3 is an exemplary block diagram illustrating a user interface displaying a Family group icon on a home screen of a mobile computing device.

FIG. 4 is an exemplary block diagram illustrating a user interface displaying aggregated notifications in a Family group icon on a home screen of a mobile computing device.

FIG. 5 is an exemplary block diagram illustrating a user interface displaying aggregated social networking updates for a Family group.

FIG. 6 is an exemplary block diagram illustrating a user interface displaying notifications for a Family group with a plurality of icons.

FIG. 7 is an exemplary block diagram illustrating a user interface displaying communication modalities for communicating with members of a Family group.

FIG. 8 is an exemplary block diagram illustrating a user interface displaying photos associated with members of a Family group.

FIG. 9 is an exemplary block diagram illustrating a user interface displaying creation of a group.

FIG. 10 is an exemplary block diagram illustrating a user interface displaying the entry of contact information for members of a Family group.

FIG. 11 is an exemplary block diagram illustrating a user interface displaying a contacts list including a Family group.

Corresponding reference characters indicate corresponding parts throughout the drawings.

### DETAILED DESCRIPTION

Referring to the figures, embodiments of the disclosure enable aggregated notifications in an icon representing a group and enable communication with members of the group via the icon. For example, a user 104 may tap on the icon to communicate with the members of the group, see updates from the members, and the like. In some embodiments, the icon is displayed or pinned to a home screen of a mobile computing device to allow easy and immediate access to updates from the group from the home screen. Aspects of the disclosure, however, are not limited to mobile computing device but are instead operable with any computing device 102. Further, the icon may be accessed from other screens associated with the computing device 102.

Aspects of the disclosure allow the user 104 to define groups of contact to reflect real-life social relationships. For example, the user 104 may form bonds with multiple, independent, small groups of people based on shared experiences and/or interests. Users such as user 104 define groups of contact entries based on these defined relationships to enable the users to stay current and connected with their contacts, to filter the high volume of received communications and feeds from their social networks, and to easily share information with the defined groups.

In some embodiments, each defined group is represented by a group icon or tile representing a visual presentation of the group of contacts. The group icon lights up or otherwise animates when communications are received from any of the members of the group associated with that group icon. Exemplary communications include one or more of the following: a presence status update, a social networking update, an electronic mail message, a text message, an instant message, a voicemail, a missed call notification, and media content (e.g., a new photo). Additional information for each of the members, such as social status updates, may be viewed from the group icon (e.g., by launching a group card showing icons corresponding to each of the members). At each level, notifications relating to received communications are aggregated for display to the user 104 through the icons, as described herein.

Aspects of the disclosure further enable display of a group card that represents up-to-date information from the members of the group pulled from multiple sources (e.g., social networking websites, photo albums, feed content, etc.). Any of the notifications can be explored to reach out to a specific member of the group. The user 104 can share information with the entire group in a single click, tap, double-click or other user-provided command.

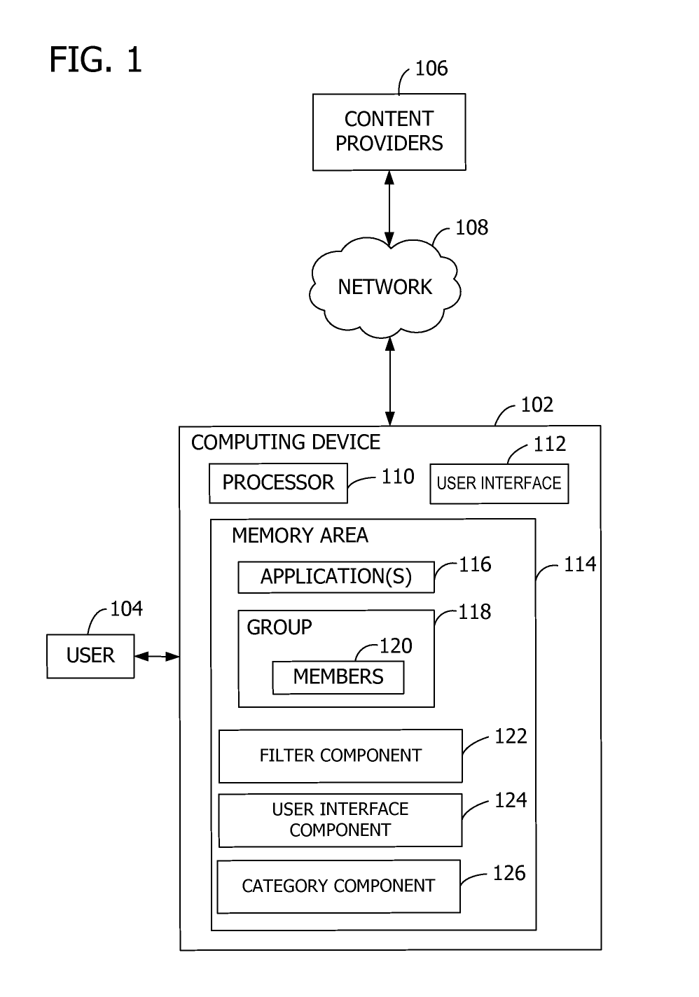

Referring again to FIG. 1, an exemplary block diagram illustrates the computing device 102 of the user 104 communicating with content providers 106 via a network 108. In the example of FIG. 1, the computing device 102 associated with the user 104 represents a system for displaying aggregated notifications in an icon or token and enabling communication with members 120 of a group 118 via the icon. The computing device 102 represents any device executing instructions (e.g., as application programs, operating system functionality, or both) to implement the operations and functionality associated with the computing device 102. The computing device 102 may include a mobile computing device or any other portable device. In some embodiments, the mobile computing device includes a mobile telephone, laptop, tablet, computing pad, netbook, gaming device, and/or portable media player. The computing device 102 may also include less portable devices such as desktop personal computers, kiosks, and tabletop devices. Additionally, the computing device 102 may represent a group of processing units or other computing devices.

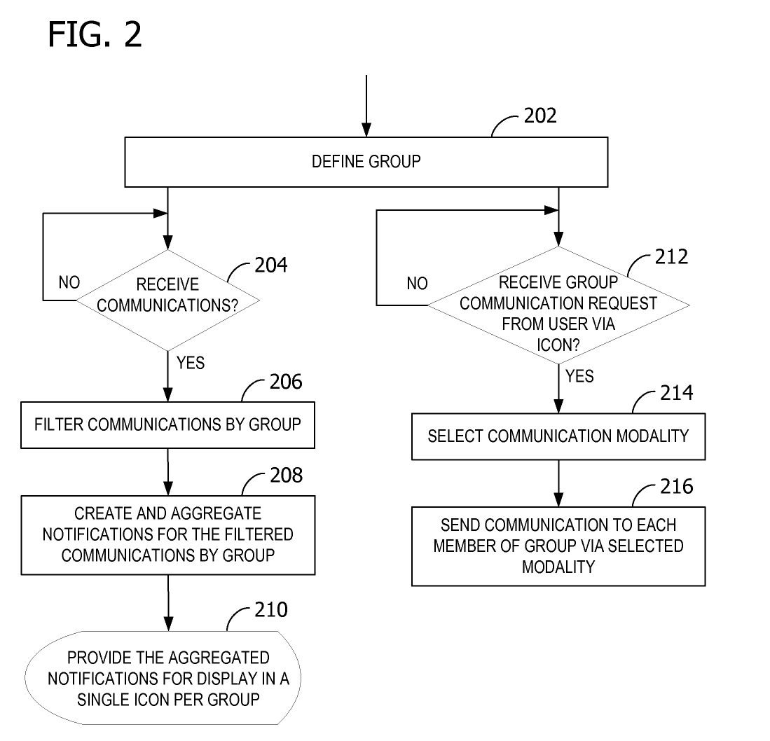

The computing device 102 has at least one processor 110, a user interface 112, and a memory area 114. The processor 110 includes any quantity of processing units, and is programmed to execute computer-executable instructions for implementing aspects of the disclosure. The instructions may be performed by the processor 110 or by multiple processors executing within the computing device 102, or performed by a processor external to the computing device 102. In some embodiments, the processor 110 is programmed to execute instructions such as those illustrated in the figures (e.g., FIG. 2).

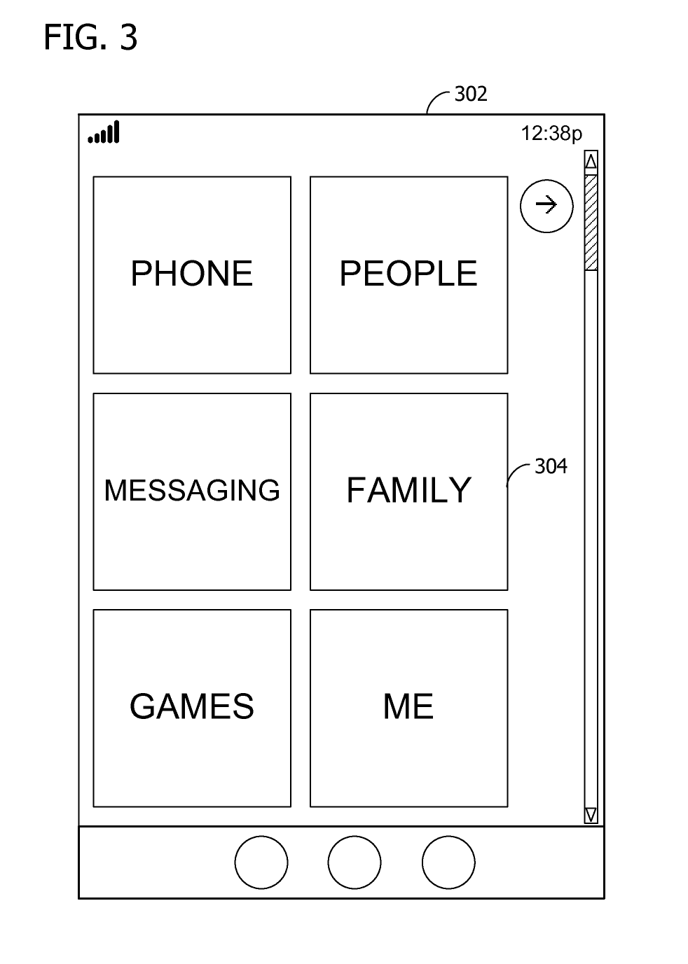

The computing device 102 also includes at least one user interface 112. The user interface 112 may have multiple screens the user 104 may navigate through by, for example, scrolling. In some embodiments, one of the screens includes a home screen that is displayed when the computing device 102 powers on. The home screen may show a summary of information of interest to the user 104 and/or may represent an entry point into launching applications available for execution by the computing device 102. An exemplary home screen is illustrated in FIG. 3 below.

In some embodiments, the computing device 102 includes a hardware graphics component for displaying data to the user 104 and/or receiving data from the user 104. The computing device 102 may also include computer-executable instructions (e.g., a driver) for operating the graphics card. Further, the computing device 102 may include a display (e.g., a touch screen display) and/or computer-executable instructions (e.g., a driver) for operating the display. The computing device 102 may also include one or more of the following to provide data to the user 104 or receive data from the user 104: speakers, a sound card, a camera, a microphone, a vibration motor, one or more accelerometers, a BLUETOOTH brand communication module, global positioning system (GPS) hardware, and a photoreceptive light sensor. For example, the user 104 may input commands or manipulate data by moving the computing device 102 in a particular way.

A communications interface (not shown) exchanges data with the content providers 106 via the network 108. The communications interface may include a network interface card and/or computer-executable instructions (e.g., a driver) for operating the network interface card. The content providers 106 include, for example, other users that send and/or receive data from the computing device 102. The members 120 of the groups 118 represent exemplary content providers 106.

The computing device 102 further has one or more computer readable media such as the memory area 114. The memory area 114 includes any quantity of media associated with or accessible by the computing device 102. The memory area 114 may be internal to the computing device 102 (as shown in FIG. 1), external to the computing device 102 (not shown), or both (not shown).

The memory area 114 stores, among other data, one or more applications 116. The applications 116, when executed by the processor 110, operate to perform functionality on the computing device 102. Exemplary applications 116 include mail application programs, web browsers, calendar application programs, address book application programs, messaging programs, media applications, location-based services, search programs, and the like. The applications 116 may communicate with counterpart applications or services such as web services accessible via the network 108. For example, the applications 116 may represent downloaded client-side applications that correspond to server-side services executing in a cloud.

The memory area 114 further stores data defining one or more groups 118. Each of the groups 118 has a plurality of members 120 associated therewith. An exemplary group 118 includes a group identifier and a set of member identifiers. The data defining the groups 118 is accessible by at least one of the applications 116 available for execution by the computing device 102. The data defining the groups 118 may also be synchronized or shared with other devices such as a cloud service.

The memory area 114 further stores one or more computer-executable components. Exemplary components include a filter component 122, a user interface component 124, and a category component 126. The components may be included as part of one of the applications 116, or may exist as a separate application 116. Operation of the components is next described with reference to FIG. 2.

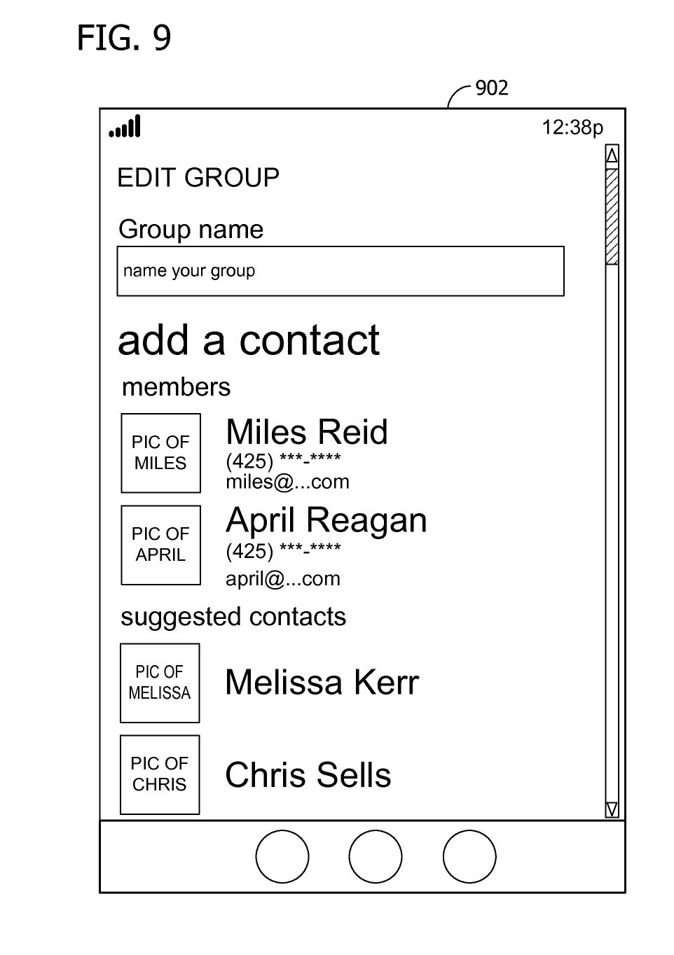

Referring next to FIG. 2, an exemplary flow chart illustrates operation of the computing device 102 to send and receive communications via a group icon. The operations illustrated in FIG. 2 may be performed whether or not the group icon exists on the home screen. In some embodiments, one or more of the operations may be performed by a web service or other cloud service in communication with the computing device 102. At 202, a group 118 is defined to include a plurality of members 120. The group 118 may be explicitly defined by the user 104 and/or implicitly and automatically defined. For example, the user 104 may select contacts to include in the group 118 (e.g., see FIG. 9). In another example, the computing device 102 or a web service automatically selects members 120 for inclusion in the group 118 (e.g., from the contacts of the user 104 such as in an address book). The computing device 102 may suggest, or automatically select, the members 120, or a subset thereof, based on one or more criteria. For example, the computing device 102 analyzes the contacts list of the user 104 to identify the significant other of the user 104, to search for the word “family” in the contact entries or data associated with the contact entries (such as in a “category” property of the contact), and to search for contacts having the same surname of the user 104. In another example, the computing device 102 gathers information about the contacts from data providers (e.g., define family relationships based on information obtained from social networking sites, or infer work relationships based on people listing the same employer name as the user, etc.). In some embodiments, the user 104 approves the suggested members 120 before inclusion in the group 118.

The computing device 102 receives one or more communications at 204. Exemplary communications include one or more of the following: a presence status update, a social networking update, an electronic mail message, a text message, an instant message, a voicemail, a missed call notification, and media content (e.g., a new photo).

The computing device 102 filters the received communications by group 118 at 206. For example, the computing device 102 identifies the sender of each received communication and determines whether the identified sender belongs to a particular group 118 defined by the user 104. The computing device 102 creates notifications associated with one or more of the received communications. The notifications may include a portion of the received communication and/or metadata describing the received communication (e.g., date, time, sender, etc.). The notifications may also represent derivations of the received communications. For example, particular words may be selected from the communications (e.g., people names, location names such as restaurants or stores, etc.). The words may be selected based on user preferences or past activity or behavior. In general, the notification provides a preview of the corresponding communication.

At 208, the computing device 102 aggregates the notifications based on group 118. In some embodiments, aggregation includes summarizing the notifications generally (e.g., “four new notifications for this group”) or summarizing the notifications with additional granularity such as by category (e.g., “three missed calls,” “two text messages,” “one new picture,” and the like).

In embodiments in which multiple notifications have been received for at least one of the members of the group 118, the notifications may be sorted, organized, prioritized, promoted, or otherwise arranged based on criteria. The sorting determines which of the notifications to present to the user 104. Example criteria include a frequency of communications and communication types between the user 104 and the member, relationship data between the user 104 and the member (e.g., based on social graph ranking, common membership in a group, or work relationship), type of notification (e.g., social networking updates take less precedence than other types of notifications), observed user interaction with previous notifications (e.g., which notifications and/or notification types are viewed first), and the like. For example, missed calls and texts are shown before status messages or photos are shown.

At 210, the aggregated notifications for each group 118 are provided for display to the user 104 in a single icon corresponding to each group 118. For example, if a web service performs operations 204, 206, and 208, the web service sends the aggregated notifications to the computing device 102 for display at 210. In another example, if the computing device 102 performs operations 204, 206, and 208, the computing device 102 displays the aggregated notifications at 210.

The aggregated notifications are displayed in a single tile or other visual icon in the user interface 112 of the computing device 102. In some embodiments, the single icon occupies a portion of the home screen in the user interface 112, such as shown in FIG. 3. In this manner, the user 104 is able to quickly obtain information relating to contacts of interest to the user 104. In embodiments in which more than group 118 is defined, one icon for each group 118 is displayed. Aggregated notifications for each of the groups 118 are displayed within each of the corresponding groups 118.

The user 104 may also communicate with members 120 of the group 118, as a whole, via the single icon corresponding to the group 118. For example, the computing device may receive a group communication request or other request from the user 104 at 212 via the icon corresponding to one of the groups 118. In some embodiments, the user 104 double-clicks on the icon, or right-clicks on the icon to select from a drop-down menu of options, to send the group 118 communication request to the computing device 102. In this manner, the user 104 selects, from the home screen in some embodiments, a single icon to enable communication with the group 118 of contacts previously selected to receive a desired communication.

The computing device 102 and/or the user 104 selects a communication modality at 214. Exemplary communication modalities include any of the following: a voice call, a text message, an instant message, and an electronic mail message. In some embodiments, the computing device 102 may automatically select a communication modality based on factors such as the type of contact information available for each member 120 in the group 118. For example, the computing device 102 may rank the communication modalities based on the number of members 120 for whom contact information is available for the communication modalities. The computing device 102 selects a communication modality able to reach the most members 120. In an example in which a mobile telephone number is available for three of the five members 120 of the group 118, the computing device 102 may select text messaging as the communication modality. Conversely, in an example in which a mobile telephone number is available for only one of the five members 120 of the group 118, the computing device 102 attempts to find a communication modality other than text messaging. In another example in which presence status information indicates that four of the five members 120 are available, the computing device 102 may select chat or instant messaging as the communication modality.

In other embodiments, the user 104 selects a communication modality. For example, the computing device 102 determines the available communication modalities based on the type and quantity of contact information available for each of the members 120. The computing device 102 presents the available communication modalities, ranked or otherwise, to the user 104 for selection. For example, the computing device 102 displays the available communication modalities and identifies the users, and/or quantity thereof, associated with each of the displayed communication modalities. The user 104 then selects the communication modality to use for communication with the group 118.

At 216, the computing device 102 sends the communication from the user 104 to each member 120 of the group 118 via the selected communication modality. In some embodiments, the computing device 102 uses an alternate communication modality to communicate with users for whom contact information for the selected communication modality is not available. For example, if a mobile telephone number is not available for a particular member 120 and the selected communication modality is text messaging, the computing device 102 may send the communication to that member 120 using an electronic mail address or other contact information available for that member 120.

In some embodiments, the computer-executable components illustrated in FIG. 1 execute to implement one or more of the operations illustrated in FIG. 2. For example, the filter component 122, when executed by the processor 110, causes the processor 110 to filter one or more communications received by the computing device 102 to identify communications from one or more members 120 of the groups 118. The filter component 122 further creates and aggregates notifications corresponding to the filtered communications.

The user interface component 124, when executed by the processes, causes the processor 110 to present the notifications aggregated by the filter component 122 in a single icon corresponding to the defined group 118. The user interface component 124 further visually distinguishes the single icon from other icons to indicate receipt of the communications. For example, the user interface component 124 may light up, highlight, add a border, brighten, flash, blink, animate, or otherwise visually distinguish the single icon representing the group 118 from other icons.

In some embodiments, the user interface component 124 further receives an icon activation request from the user 104. For example, the user 104 may double-click the icon representing one of the groups 118, or right-click the icon and select from a pull-down menu, to submit the icon activation request. In response to detection or receipt of the icon activation request, the category component 126, when executed by the processor 110, causes the processor 110 to present a plurality of icons. Each of the plurality of icons corresponds to one of a plurality of notification categories. In some embodiments, the notification categories correspond to the communication modalities associated with the notifications. For example, the plurality of icons may correspond to text messages, instant messages, electronic mail, voice calls, and the like. The notification categories may also include photos, music, and other media content. The category component 126 may display icons corresponding to each of the notification categories whether or not a notification is available for that category, or the category component 126 may display icons corresponding only to the notification categories for which a notification is available.

Each notification is displayed, or summarized, in the icon corresponding to the category of the notification. For example, the icon corresponding to text messages may display “two new text messages” or may display a list of contacts from whom unread text messages have been recently received. In some embodiments, the category component 126 or the user interface component 124 further visually distinguishes each of the plurality of icons having at least one of the notifications displayed therein.

Referring next to FIG. 3, an exemplary block diagram illustrates a user interface 302 displaying a Family group icon 304 on a home screen of the mobile computing device. In the example of FIG. 3, six icons are displayed. One of the six icons corresponds to the Family group. The home screen represents an entry point or launching point into other functionality available on the mobile computing device. For example, the home screen is displayed after booting the mobile computing device.

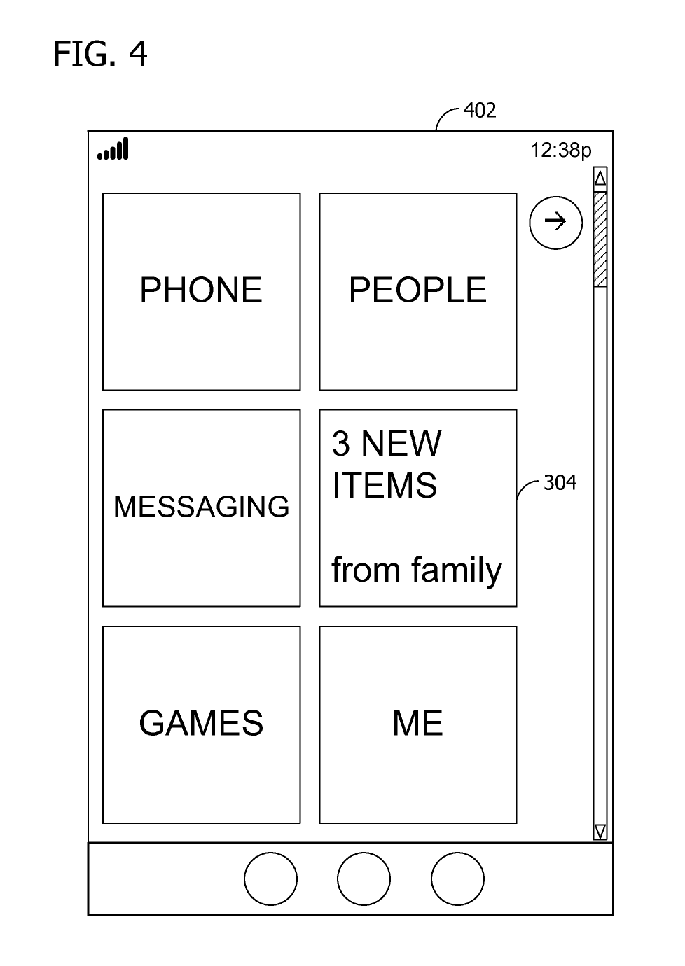

Referring next to FIG. 4, an exemplary block diagram illustrates a user interface 402 displaying aggregated notifications in the Family group icon 304 on the home screen of a mobile computing device. In the example of FIG. 4, the Family group icon 304 displays “3 New Items” to indicate that three items have been received from members of the Family group. In some embodiments, the Family group icon 304 may alternate between the information displayed in FIG. 4 and the information displayed in the Family group icon 304 in FIG. 3. In other embodiments, the Family group icon 304 displays either the information shown in FIG. 3 or in FIG. 4.

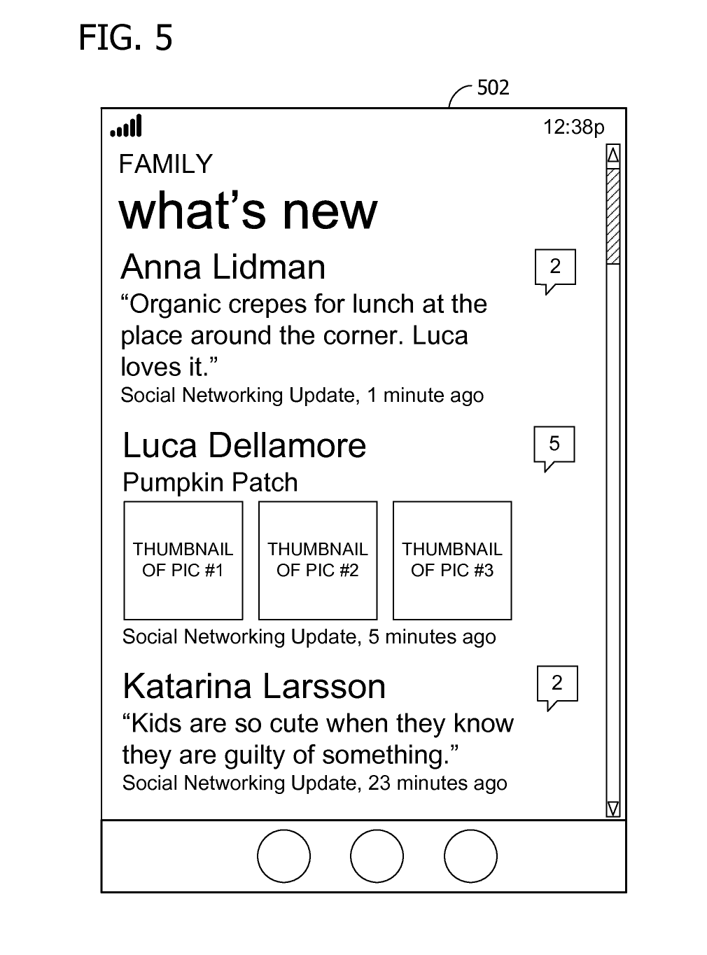

Referring next to FIG. 5, an exemplary block diagram illustrates a user interface 502 displaying aggregated notifications for the Family group. While the “what's new” page may show any notifications or feed content relating to members of the Family group aggregated across all members of the Family group, the example “what's new” page in FIG. 5 displays the social networking updates aggregated across all members of the Family group. For example, the social networking updates include comments and photographs.

The user 104 navigated to the “what's new” page for the Family group by, for example, double-clicking on the Family group icon 304 shown in FIG. 3 or FIG. 4. In this example, the Family group icon may have displayed “3 New Social Updates from the Family Group.”

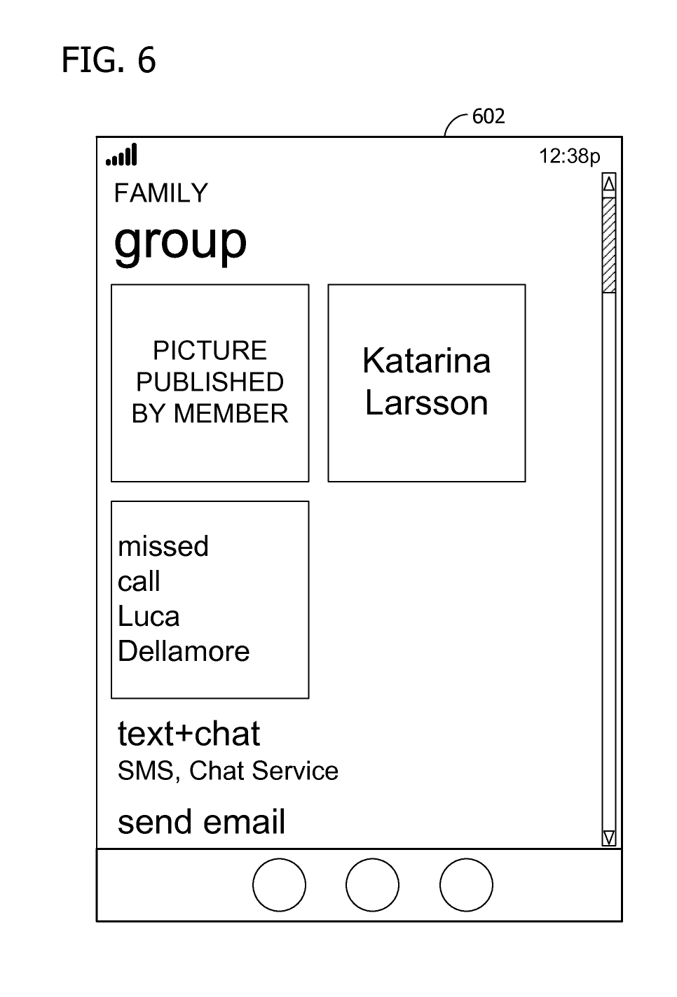

Other notifications from members of the Family group (such as text messages, chats, missed calls, voicemails, and emails) may be aggregated on another screen, such as shown in FIG. 6 below.

Referring next to FIG. 6, an exemplary block diagram illustrates a user interface 602 displaying notifications for the Family group with a plurality of icons. The user 104 navigated to the “group” page for the Family group by, for example, double-clicking on the Family group icon 304 shown in FIG. 3 or FIG. 4.

The icons illustrated in FIG. 6 are tiles, one per contact in the Family group, that show a picture associated with the contact. The tiles “flip” to reveal information about the contact. For example, each tile shows notifications associated with the contact (e.g., a missed call from the contact, a new email, a new text message, a social networking update, a photo published by the contact, voicemail, etc.) aggregated on the tile. In the example of FIG. 6, one of the tiles indicates a missed call. Activating or otherwise selecting each contact card takes the user 104 to a history of communications with the member associated with the activated contact card. In this manner, the notifications for the Family group are aggregated in the user interface 602.

The example of FIG. 6 also includes options for communicating with the members of the Family group. The options include communication via short message service (SMS) messages for texting or chatting, and for sending electronic mail messages. Activation of these options (e.g., by the user 104 double-clicking on the text displayed in the user interface) enables the user 104 to communicate with each of the members of the Family group, as next described. For example, the option “text +chat” is displayed and, when activated by the user 104, results in display of the options for communicating with members of the Family group.

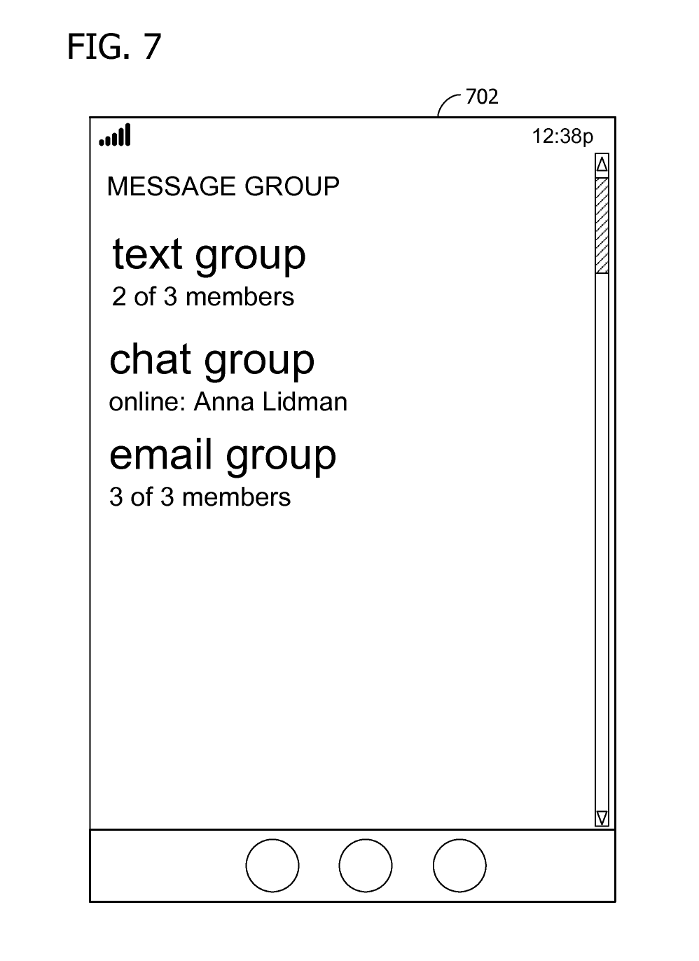

Referring next to FIG. 7, an exemplary block diagram illustrates a user interface 702 displaying communication modalities for communicating with members of the Family group. The communication modalities represent forms of communication with the members. In some embodiments, the computing device 102 determines which communication modalities are available for the Family group based on contact information available for the members, and presents only the communication modalities for which sufficient contact information is available. In other embodiments, the computing device 102 presents all communication modalities available from the computing device 102, whether or not sufficient contact information for the members is available. In such embodiments, the computing device 102 may identify the contact information that is missing and for which of the members, and then enable the user 104 to provide the missing contact information.

The user 104 navigated to the “message group” page shown in FIG. 7 by, for example, double-clicking on the communication options illustrated in FIG. 6. In another example, the user 104 navigated to the “message group” page from the home screen (e.g., by right-clicking on the Family group icon 304 to select “message group”). The communication modalities illustrated in FIG. 7 include texting, chatting, and emailing. The computing device 102 presents further information relating to the members and to the communication modalities. In the example of FIG. 7, the computing device 102 informs the user 104 that two of the three members of the Family group can be reached by text messaging (e.g., a mobile telephone number is available for two of the three members). The computing device 102 also indicates that one of the members is available for a chat (e.g., presence information indicates that Anna Lidman is currently online). The computing device 102 also indicates that three of the three members can be reached by email (e.g., email addresses are available for the three members). The word “everyone” may alternatively be displayed in FIG. 7 for the email communication modality.

When the user 104 selects one of the communication modalities (e.g., by clicking or double-clicking on the text representing the communication modalities), the user 104 is able to enter information for delivery to the available members. For example, the computing device 102 displays another screen, page, a popup, or other user interface element for entry by the user 104 of the information to deliver.

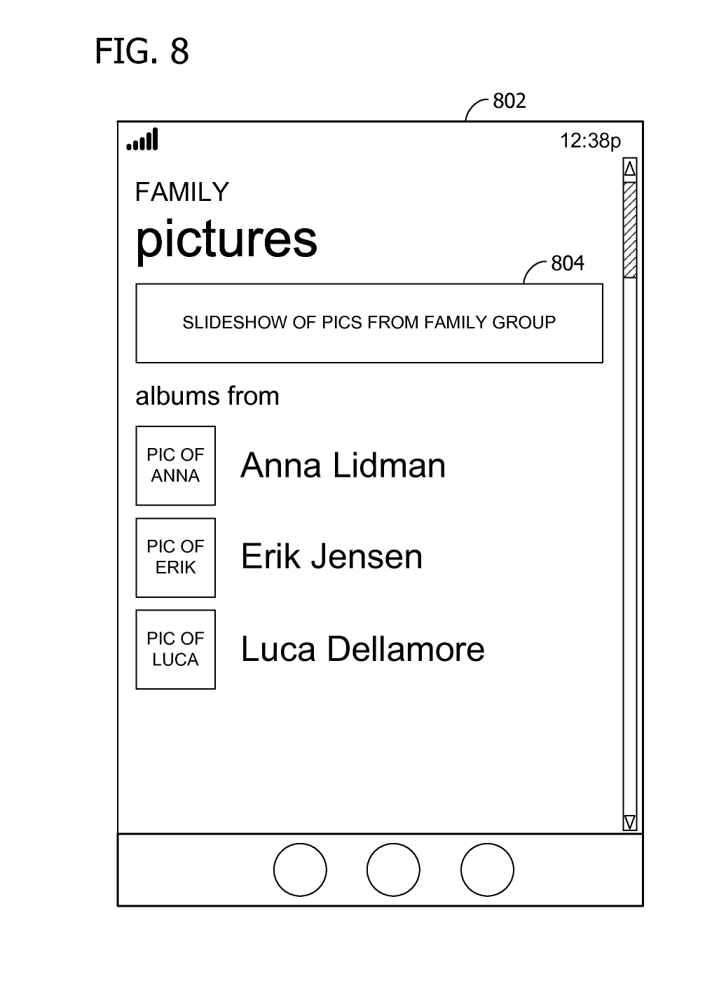

Referring next to FIG. 8, an exemplary block diagram illustrates a user interface 802 displaying photos associated with members of the Family group. The “family pictures” page displays photo albums from the members. For example, the computing device 102 filters the photo albums available on the computing device 102 to identify only the photo albums from the members of the Family group. The user 104 navigated to the “family pictures” page shown in FIG. 8 by, for example, right-clicking on the Family group icon 304 on the home screen illustrated in FIG. 3 or FIG. 4 to select an option to display the “family pictures” page. In another example, the user 104 navigated to the “family pictures” page from the user interface 602 illustrated in FIG. 6.

In some embodiments, the user interface 802 further displays a slideshow of pictures 804 from members of the Family group in a dynamic tile, slab, or other entry point. The pictures 804 represent tagged photos from all members of the Family group aggregated into the single dynamic tile. The pictures 804 may include one photo at a time or multiple photos in a rotating animation sequence as long as the user 104 stays on this screen. When the user closes the user interface 802 and later returns, a different set of photos may be displayed depending on availability of the photos.

Referring next to FIG. 9, an exemplary block diagram illustrates a user interface 902 displaying creation of a group. The “edit group” page allows the user 104 to create or edit a group. The page shows the current members of the group along with suggested contacts. The computing device 102, or cloud service, identifies the suggested contacts based on previous communications from the user 104 (e.g., email, phone, etc.) or other criteria. The user 104 may add and/or delete members from the group via the page illustrated in FIG. 9, in some embodiments.

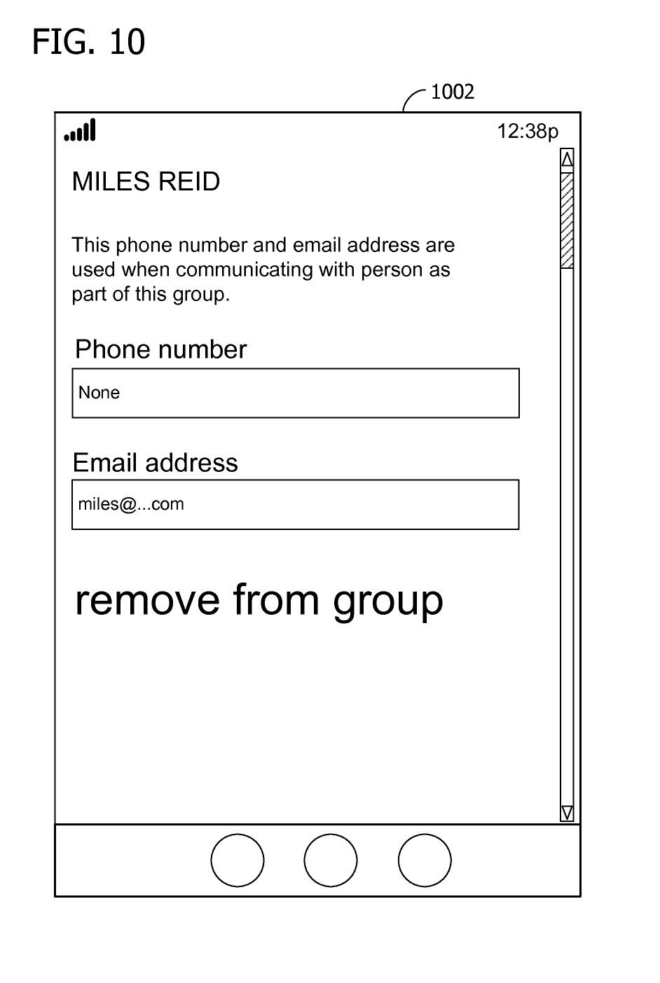

Referring next to FIG. 10, an exemplary block diagram illustrates a user interface 1002 displaying the entry of contact information for members of the Family group. In the example of FIG. 10, the user 104 selects (or inputs) contact information including a phone number and email address to use for member Miles Reid. The user 104 may also remove member Miles Reid from the Family group.

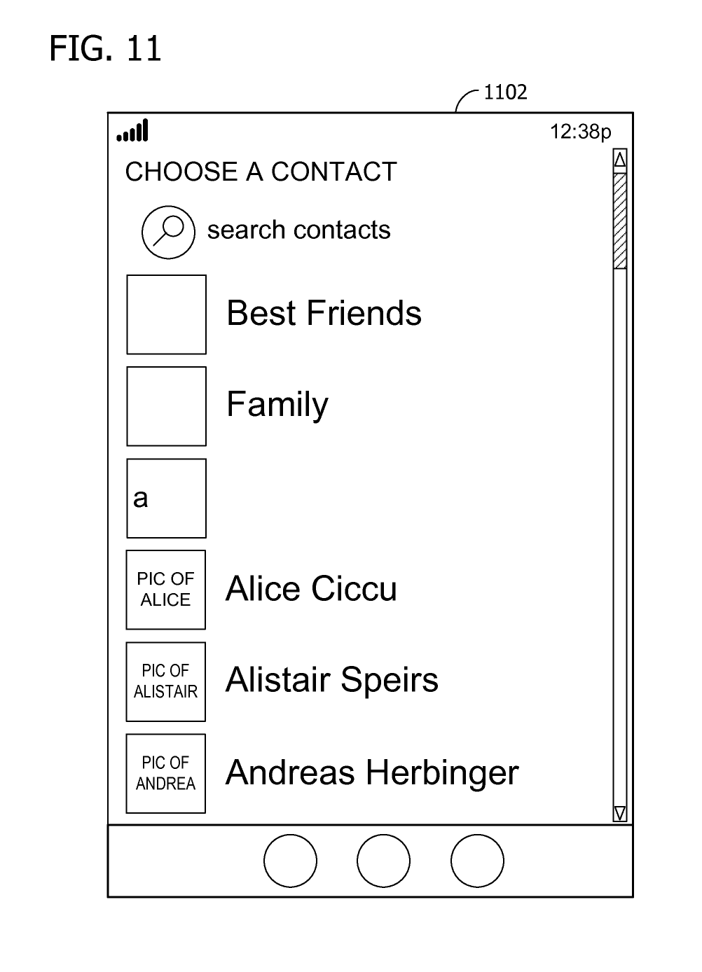

Referring next to FIG. 11, an exemplary block diagram illustrates a user interface 1102 displaying a contacts list including the Family group. In the example of FIG. 11, the user 104 is able to view inbound communications via the Family icon in the contact list. The user 104 is also able to send an outbound communication to each of the members of the Family group as a group via the Family group icon displayed in the contact list illustrated in FIG. 11.

While the Family group icon is displayed in the contacts list of FIG. 11, aspects of the disclosure contemplate a plurality of group icons displayed in the contact list.

### ADDITIONAL EXAMPLES

In some embodiments, the user 104 are able to group contacts from multiple different networks (e.g., different sources, entities, or accounts) into a single group 118 to enable aggregation of notifications from those contacts. For example, if the user 104 has accounts set up on the mobile computing device for a social networking website, a mail account, and a microblog account, the user 104 is able to have contacts from each of these networks in a single group 118 at the same time. The user 104 is thus able to see aggregated feeds, pictures, notifications, etc. for any of the grouped contacts.

At least a portion of the functionality of the various elements in FIG. 1 may be performed by other elements in FIG. 1, or an entity (e.g., processor, web service, server, application program, computing device, etc.) not shown in FIG. 1.

In some embodiments, the operations illustrated in FIG. 2 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users such as user 104. In such embodiments, notice is provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media exclude propagated data signals. In some embodiments, computer storage media are implemented in hardware. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for displaying the aggregated notifications via the icon and enabling communication with members of the group via the icon, and exemplary means for providing the user 104 with access to the received communications from members of the group via the icon.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for displaying aggregated notifications in an icon and enabling communication with members of a group via the icon, said system comprising:
a memory area associated with a mobile computing device of a user, said memory area identifying a plurality of members associated with a group;
a user interface having a home screen associated therewith; and
a processor programmed to:
receive communications from one or more of the members of the group;
aggregate notifications corresponding to the received communications;
display, in the home screen of the user interface, the aggregated notifications for access by the user via a single icon corresponding to the defined group;
receive, via the single icon, a request from the user to communicate with the defined group;
select a communication modality for one or more of the members of the group; and
send a communication to each of the one or more members via the selected communication modality.

2. The system of claim 1, wherein the processor is further programmed to:
access a plurality of contacts of the user; and
select, based on one or more criteria, a subset of the accessed plurality of contacts to define the group.

3. The system of claim 1, wherein the memory area is accessible by a plurality of applications executing on the mobile computing device.

4. The system of claim 1, wherein the processor is further programmed to allow the user to edit the defined group.

5. The system of claim 1, further comprising means for displaying the aggregated notifications via the icon and enabling communication with members of the group via the icon.

6. The system of claim 1, further comprising means for providing the user with access to the received communications from members of the group via the icon.

7. A method comprising:
defining a group to include a plurality of members;
receiving, by a computing device, one or more communications;
filtering the received communications to identify communications received from one or more of the members of the defined group;
aggregating, by the computing device, notifications corresponding to the filtered communications; and
providing, for display on the computing device, the aggregated notifications for access by the user via a single icon corresponding to the defined group.

8. The method of claim 7, wherein defining the group comprises automatically selecting a plurality of contacts of a user based on one or more criteria.

9. The method of claim 7, further comprising sending a communication from a user of the computing device to each of the members via the icon.

10. The method of claim 9, wherein sending the communication comprises:
selecting a communication modality for one or more of the members; and
sending the communication to each of the one or more members via the corresponding selected communication modality.

11. The method of claim 10, wherein selecting the communication modality comprises selecting a communication modality from one of the following: a voice call, a text message, an instant message, and an electronic mail message.

12. The method of claim 10, wherein selecting the communication modality comprises automatically selecting a communication modality based on a presence status associated with each of the members.

13. The method of claim 10, further comprising identifying the one or more members to a user of the computing device.

14. The method of claim 7, wherein aggregating the notifications comprises aggregating a portion or derivation of each of the filtered communications.

15. The method of claim 7, wherein receiving the communications comprises receiving one or more of the following: a presence status update, a social networking update, an electronic mail message, a text message, an instant message, a voicemail, a missed call notification, and media content.

16. The method of claim 7, wherein defining the group comprises:
receiving from a user a selection of contacts associated with the user; and
defining the group to include the selected contacts.

17. One or more computer storage media embodying computer-executable components, said components comprising:
a filter component that when executed causes at least one processor to filter one or more communications received by a computing device to identify communications from one or more members of a group, said filter component further aggregating notifications corresponding to the filtered communications;
a user interface component that when executed causes at least one processor to present the notifications aggregated by the filter component via a single icon corresponding to the defined group, wherein the user interface component further visually distinguishes the single icon from other icons to indicate receipt of the communications; and
a category component that when executed causes at least one processor to present, responsive to an icon activation request received from the user via the single icon, a plurality of icons each corresponding to one of a plurality of notification categories, wherein the user interface component presents each of the filtered notifications via one of the plurality of icons based on the notification category corresponding thereto.

18. The computer storage media of claim 17, wherein the user interface component further visually distinguishes each of the plurality of icons having at least one of the notifications presented therein.

19. The computer storage media of claim 17, wherein the user interface component presents the notifications in a single icon on a home screen of a computing device.

20. The computer storage media of claim 17, wherein the notification categories comprise one or more of the following: photos, music, missed calls, and text.
